(19) United States
(12) Patent Application Publication
(10) Pub. No.: US 2008/0055805 A1
(43) Pub. Date: Mar. 6, 2008

(54) SEMICONDUCTOR DEVICE HAVING ELECTRO STATIC DISCHARGE DETECTION CIRCUIT

(75) Inventors: Won-Hyung Pong, Gyeonggi-do (KR); Jong-Sung Jeon, Gyeonggi-do (KR); Young-Chul Kim, Gyeonggi-do (KR)

Correspondence Address: MYERS BIGEL SIBLEY & SAJOVEC, PO BOX 37428, RALEIGH, NC, 27627, US

(73) Assignee: SAMSUNG ELECTRONICS CO., LTD.

(21) Appl. No.: 11/754,685

(22) Filed: May 29, 2007

(30) Foreign Application Priority Data
May 30, 2006 (KR) 10-2006-0048951

(51) Int. Cl. H02H 9/04; H02H 9/00

(52) U.S. Cl. 361/56

(57) ABSTRACT

A semiconductor device having an electro static discharge (ESD) protection circuit includes an input/output pad configured to receive a voltage higher than an operating voltage of the semiconductor device and an ESD (electro static discharge) protection circuit configured to protect an internal circuit of the semiconductor device from ESD when ESD occurs at the input/output pad. The ESD protection circuit may include a protection circuit configured to flow the ESD current into an operating voltage line and/or a ground voltage line, an ESD detection circuit configured to detect the ESD current flowing in the operating voltage line, and a control circuit configured to cause the protection circuit to be coupled to, or isolated from, the ground voltage line in response to an output signal of the ESD detection circuit.

### CROSS-REFERENCE TO RELATED APPLICATIONS

This U.S. non-provisional patent application claims priority under 35 U.S.C. § 119 to Korean Patent Application No. 2006-48951, filed on May 30, 2006, the disclosure of which is hereby incorporated by reference.

### BACKGROUND

The present invention relates to semiconductor devices, and more particularly, to semiconductor devices having an electro static discharge (ESD) protection circuit.

ESD is a phenomenon caused by the discharge of static electricity. That is, ESD is a high voltage discharge of static electricity, which may be larger than the breakdown voltage of a typical semiconductor device. When ESD occurs, it may damage semiconductor devices. A high voltage that suddenly appears at an input/output pad connected to an input or output circuit may damage a gate insulation layer of a semiconductor device in the circuit, such as a MOS transistor. Additionally, transient currents due to static electricity may damage an input or output circuit.

ESD protection for an integrated circuit device may be provided by an ESD protection circuit. The level of ESD protection provided by the ESD protection circuit may be determined by the layout and manufacturing process used to form the ESD protection circuit. However, ESD evaluation standards may be equal for all kinds of semiconductor devices. Additionally, as semiconductor devices become more and more integrated, the size of the semiconductor devices becomes smaller, and manufacturing processes become more complex. Therefore, new ESD protection circuits are needed for providing ESD protection characteristics using new layout design rules that are determined by the manufacturing processes.

Conventional ESD protection circuits may be provided on both sides of an input/output pad to promptly detour an overcurrent generated by ESD, in order to protect the semiconductor device. This is typically done by operation of a parasitic bipolar transistor associated with the device, which is induced by application of a high voltage to a drain of the protection device.

FIG. 1 is a circuit diagram of a semiconductor device having a conventional ESD protection circuit 10 and an internal circuit 20. The ESD protection circuit 10 includes a PMOS transistor P and stacked NMOS transistors N1 and N2. A tolerant input/output pad IO is used for inputting and outputting a voltage higher than an operating voltage VDD. The PMOS transistor P is connected between the input/output pad IO and an operating voltage VDD line. The PMOS transistor P may prevent a high voltage applied to the input/output pad IO from affecting the operating voltage VDD. The first and second NMOS transistors N1 and N2 are connected in a stacked configuration between the input/output pad IO and a ground voltage VSS line. A gate of the first NMOS transistor N1 is connected to the operating voltage VDD line. This may prevent the high voltage from being applied between the input/output pad IO and the gate of the first NMOS transistor N1, thereby possibly preventing gate oxide layer from being damaged.

However, when ESD occurs in the input/output pad IO, an ESD current increases the electric potential of the input/output pad IO. At this point, the PMOS transistor P and the NMOS transistors N1 and N2 are in a reverse bias mode.

Since the NMOS transistors N1 and N2 are connected in a stacked configuration, they collectively have a higher breakdown voltage than the PMOS transistor P. Referring still to FIG. 1, the ESD current initially passes through the PMOS transistor P and flows into the operating voltage VDD line. The ESD current flowing in the operating voltage VDD line increases the electric potential of the operating voltage VDD line. The increased electric potential is applied to the gate of the first NMOS transistor N1. If a voltage in the gate of the first NMOS transistor N1 is higher than a threshold voltage Vth, a channel of the first NMOS transistor N1 is turned on. Moreover, the ESD current continuously increases an electric potential of the input/output pad IO. When the electric potential of the input/output pad IO becomes higher than the breakdown voltages of the NMOS transistors N1 and N2, the ESD current flows into the ground voltage VSS line through the NMOS transistors N1 and N2.

The ESD currents which flows into the ground voltage VSS line due to the ESD current flowing into the line of the operating voltage VDD, is concentrated on a channel edge of the first NMOS transistor N1. As a result, the first NMOS transistor N1 may be damaged.

### SUMMARY

A semiconductor device according to some embodiments of the invention may include an input/output pad configured to receive a voltage higher than an operating voltage of the semiconductor device, and an ESD (electro static discharge) protection circuit coupled to the input/output pad and configured to protect an internal circuit of the semiconductor device from an ESD current at the input/output pad. The ESD protection circuit may include a protection circuit coupled to the input/output pad and configured to direct the ESD current into an operating voltage line and/or a ground voltage line, an ESD detection circuit coupled to the operating voltage line and configured to detect the ESD current flowing in the operating voltage line and configured to generate an output signal in response to the ESD current flowing in the operating voltage line, and a control circuit coupled to the ESD detection circuit and the protection circuit and configured to cause the protection circuit to be coupled to, or isolated from, the ground voltage line in response to the output signal from the ESD detection circuit.

The protection circuit may include a PMOS transistor having a source connected to the operating voltage line, a drain connected to the input/output pad, and a gate connected to a substrate, a first NMOS transistor having a drain connected to the input/output pad, and a second NMOS transistor having a drain connected to a source of the first NMOS transistor, and a source connected to the ground voltage line. The control circuit may be configured to control a gate of the first NMOS transistor, and the internal circuit may configured to control a gate of the second NMOS transistor.

The gate of the first NMOS transistor may be connected to the operating voltage line when ESD does not occur.

The semiconductor device may further include a resistor connected between the gate of the first NMOS transistor and the operating voltage line.

The control circuit may be configured to cut off a channel of the first NMOS transistor in response to ESD.

The control circuit may be configured to latch an output of the ESD detection circuit to cut off the channel of the first NMOS transistor.

The control circuit may include a first inverter configured to receive and reverse an output of the ESD detection circuit, and configured to apply the reversed output to the gate of the first NMOS transistor, and a second inverter configured to receive and reverse the output of the first inverter, and configured to apply the reversed output to the first inverter.

The first inverter may include a first PMOS transistor having a source connected to the operating voltage line, and a third NMOS transistor having a drain connected to a drain of the first PMOS transistor, a source connected to the ground voltage line, and a gate connected to a gate of the first PMOS transistor, and the second inverter may include a second PMOS transistor having a source connected to the operating voltage line, and a fourth NMOS transistor having a drain connected to a drain of the second PMOS, a source connected to the ground voltage line, and a gate connected to a gate of the second PMOS transistor. The gate of the first PMOS transistor may be connected to the drain of the second PMOS transistor and may be configured to receive an output of the detection circuit, and the drain of the first PMOS transistor may be connected to the gate of the second PMOS transistor and may be connected to the gate of the first NMOS transistor.

The ESD detection circuit may include a capacitor connected to the operating voltage line and a sensing node, and a resistor connected to the sensing node and the ground voltage line.

The protection circuit may include a PMOS transistor having a source connected to the operating voltage line, a drain connected to the input/output pad, and a gate connected to a substrate, a first NMOS transistor having a drain connected to the input/output pad, and a second NMOS transistor having a drain connected to a source of the first NMOS transistor, and a source connected to the ground voltage line. The control circuit may be configured to control gates of the first NMOS transistor and the second NMOS transistor.

The gate of the first NMOS transistor may be connected to the operating voltage line when ESD does not occur.

The semiconductor device may further include a resistor between the gate of the first NMOS transistor and the operating voltage line.

The control circuit may include a latch circuit configured to latch an output of the ESD detection circuit, and a switch circuit configured to receive an output of the latch circuit and to open channels of the first and second NMOS transistors in response to the output of the latch circuit.

The ESD detection circuit may include a capacitor connected to the operating voltage line and the sensing node, and a resistor connected to the sensing node and the ground voltage line.

The latch circuit may include a first inverter configured to reverse an output of the ESD detection circuit and to apply the reversed output to the switch circuit, and a second inverter configured to reverse an output of the first inverter and to apply the reversed output to the first inverter.

The first inverter may include a first PMOS transistor having a source connected to the operating voltage line, and a third NMOS transistor having a drain connected to a drain of the first PMOS transistor, a source connected to the ground voltage line, and a gate connected to a gate of the first PMOS transistor. The second inverter may include a second PMOS transistor having a source connected to the operating voltage line, and a fourth NMOS transistor having a drain connected to a drain of the second PMOS, a source connected to the ground voltage line, and a gate connected to a gate of the second PMOS transistor. The gate of the first PMOS transistor may be connected to the drain of the second PMOS transistor and may be configured to receive an output of the detection circuit, and the drain of the first PMOS transistor may be connected to the gate of the second PMOS transistor and connected to the gate of the first NMOS transistor.

The switching circuit may include a third PMOS transistor having a source connected to the operating voltage line, and a gate configured to receive an output of the latch circuit, and a resistor connected to a drain of the third PMOS transistor and the ground voltage line. The source of the third PMOS transistor may be connected to the gate of the first NMOS transistor and the drain of the third PMOS transistor may be connected to the gate of the second NMOS transistor.

The input/output pad may include a tolerant input/output pad.

### BRIEF DESCRIPTION OF THE FIGURES

The accompanying figures are included to provide a further understanding of the present invention, and are incorporated in and constitute a part of this specification. The drawings illustrate exemplary embodiments of the present invention and, together with the description, serve to explain principles of the present invention. In the figures:

FIG. 1 is a circuit diagram of a semiconductor device having a conventional ESD protection circuit;

FIG. 2 is a circuit diagram of a semiconductor device having an ESD protection circuit according to some embodiments of the present invention;

FIG. 3A is a sectional view of a PMOS transistor of a protection circuit of FIG. 2;

FIG. 3B is a view of an equivalent circuit of FIG. 3A:

FIG. 4 is a circuit diagram of a semiconductor device having an ESD protection circuit according to further embodiments of the present invention; and

FIG. 5 is a view of current-voltage characteristics of semiconductor devices according to embodiments of the present invention.

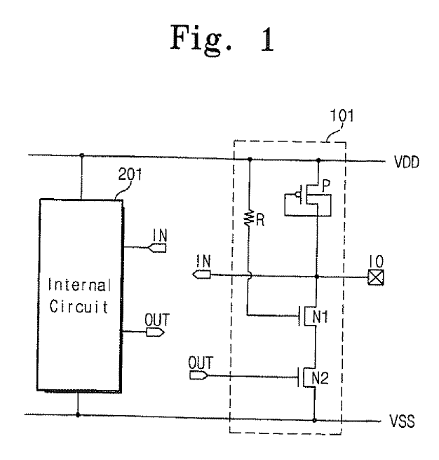

### DETAILED DESCRIPTION OF EMBODIMENTS OF THE INVENTION

Embodiments of the present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

It will be understood by those having skill in the art that as used herein, the term “MOS transistor” refers to any insulated gate field effect transistor, the gate of which comprises metal and/or nonmetal (such as polysilicon) and the insulator of which comprises oxide and/or other insulators (such as high dielectric constant insulators).

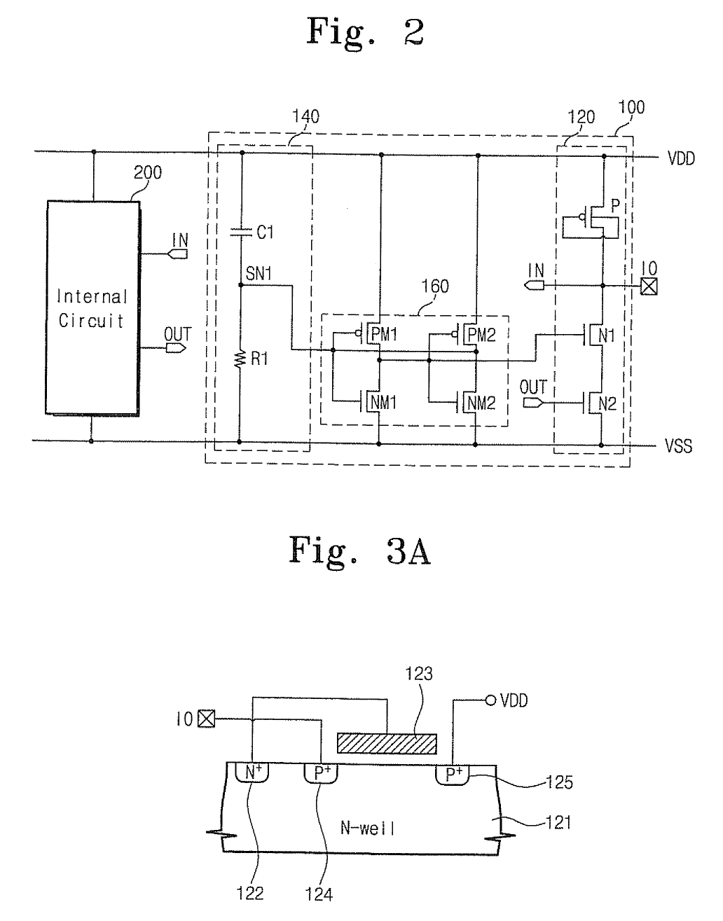

FIG. 2 is a circuit diagram of a semiconductor device having an ESD protection circuit according to some embodiments of the present invention. Referring to FIG. 2, the semiconductor device includes an input/output pad IO, an ESD protection circuit 100, and an internal circuit 200.

The input/output pad IO can be a tolerant input/output pad. Unlike a conventional input/output pad, a voltage higher than an operating voltage VDD may be applied to the tolerant input/output pad IO.

The ESD protection circuit 100 protects the internal circuit 200 of the semiconductor device from ESD when ESD occurs at the input/output pad IO. Referring to FIG. 7 the ESD protection circuit 100 includes a protection circuit 120, an ESD detection circuit 140, and a control circuit 160.

The protection circuit 120 is connected between an operating voltage VDD line and a ground voltage VSS line. The protection circuit 120 causes an ESD current at the input/output pad IO to flow into the operating voltage VDD line and/or the ground voltage VSS line, thereby protecting the internal circuit 200 of the semiconductor device.

The protection circuit 120 includes a PMOS transistor P and NMOS transistors N1 and N2. The protection circuit 120 directs the ESD current of the input/output pad IO into the operating voltage VDD line through the PMOS transistor P, and into the ground voltage VSS line through the NMOS transistors N1 and N2, which are connected in a stacked configuration.

Referring to FIG. 2, a source of the PMOS transistor P is connected to the operating voltage VDD line, its drain is connected to the input/output pad IO, and its gate is connected to its substrate.

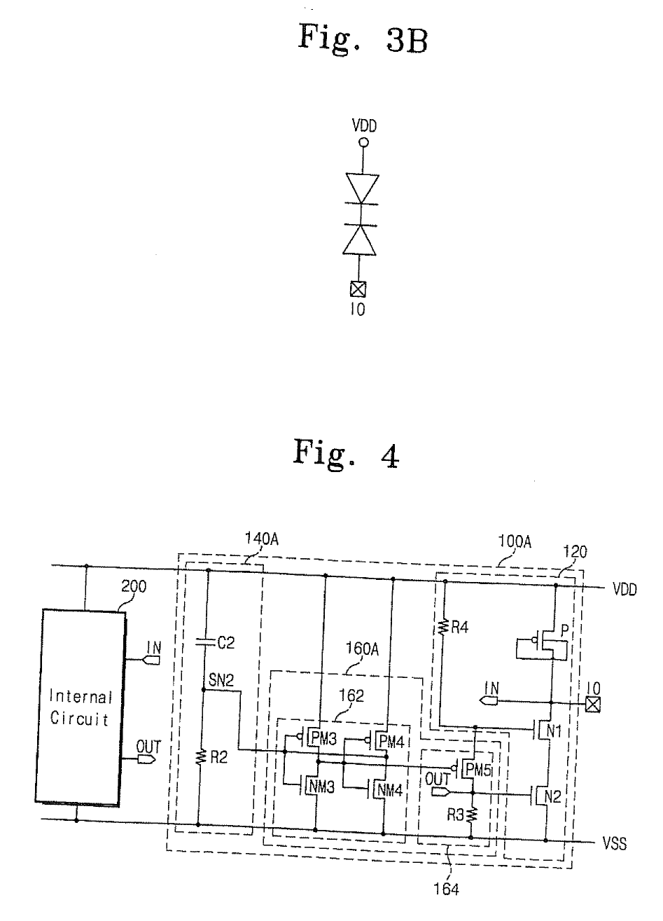

FIG. 3A is a sectional view of a PMOS transistor P of a protection circuit 120 of FIG. 2. A gate electrode 123 of the PMOS transistor P is connected to a substrate electrode 122 of an N-type substrate 121. Since the N-type substrate 121 is in a floating state, the gate of the PMOS transistor P is in a floating state. A drain electrode 124 is connected to the input/output pad IO, and a source electrode 125 is connected to the operating voltage VDD line. At this point, the PMOS transistor P appears as a forward biased P-N diode and a reverse biased P-N diode connected in serial as shown in FIG. 3B.

Under normal device operation, the PMOS transistor P of the protection circuit 120 acts as a reverse biased P-N diode. Thus, a high voltage signal applied to the input/output pad IO should not affect the operating voltage VDD line.

Processes of directing the ESD current into the operating voltage VDD line through the PMOS transistor P are as follows. As the electric potential of the input/output pad IO is increased by the ESD current and exceeds a breakdown voltage of the PMOS transistor P, the ESD current flows into the operating voltage VDD line through the PMOS transistor P.

The NMOS transistors N1 and N2 are connected in a stacked configuration relative to one another. A drain of the first NMOS transistor N1 is connected to the input/output pad IO. A drain of the second NMOS transistor N2 is connected to a source of the first NMOS transistor N1, and its source is connected to the ground voltage VSS line.

Processes of directing the ESD current into the ground voltage VSS line through the NMOS transistors N1 and N2 are as follows. As an electric potential of the input/output pad IO exceeds breakdown voltages of the NMOS transistors N1 and N2, the ESD current flows into the ground voltage VSS line through the NMOS transistors N1 and N2.

The ESD detection circuit 140 is connected between the operating voltage VDD line and the ground voltage VSS line and detects the ESD current flowing in the operating voltage VDD line. A voltage level is formed by detecting the ESD current that flows in the operating voltage VDD line. The ESD detection circuit 140 delivers the voltage level into the control circuit 160.

The ESD detection circuit 140 includes a capacitor C1 and a resistor R1. The capacitor C1 is connected between the operating voltage VDD line and a sensing node SN1. The resistor R1 is connected to the capacitor C1 and the ground voltage VSS line.

The capacitor C1 detects the ESD current flowing in the operating voltage VDD line when ESD occurs at the input/output pad IO. When ESD occurs in the input/output pad IO, a path where the ESD current flows is as follows. An electric potential of the input/output pad IO is increased by the ESD current. When the electrical potential of the increased input/output pad IO exceeds a breakdown voltage of the PMOS transistor P, the ESD current passes through the PMOS transistor P, and flows into the operating voltage VDD line. The ESD current flowing in the operating voltage VDD line charges the capacitor C1. Consequently, the voltage at the sensing node SN1 increases.

The control circuit 160 controls a gate of the first NMOS transistor N1 in response to the sensing node SN1 of the ESD detection circuit 120. The control circuit 160 has a latch structure having two inverters interlocked to each other. The control circuit 160 reverses and latches an output of the ESD detection circuit 140, and then inputs the reversed output into the gate of the first NMOS transistors N1. The reason of latching an output value of the ESD detection circuit 140 is that the ESD current generated by ESD may be instantaneous.

The control circuit 160 includes first and second inverters connected to form a latch.

The first inverter includes a PMOS transistor PM1 and an NMOS transistor NM1. A source of the PMOS transistor PM1 is connected to the operating voltage VDD line. A drain of the NMOS transistor NM1 is connected to a drain of the PMOS transistor PM1, its source is connected to the ground voltage VSS line, and its gate is connected to a gate of the PMOS transistor PMD.

The second inverter includes a PMOS transistor PM2 and an NMOS transistor NM2. A source of the PMOS transistor PM2 is connected to the operating voltage VDD line. A drain of the NMOS transistor NM2 is connected to a drain of the PMOS transistor PM2, its source is connected to the ground voltage VSS line, and its gate is connected to a gate of the PMOS transistor PM2.

The gate of the PMOS transistor PM1 is connected to the drain of the PMOS transistor PM2. A drain of the PMOS transistor PM1 is connected to the gate of the PMOS transistor PMD.

The gate of the PMOS transistor PM1 receives an output of the ESD detection circuit 120. The drain of the PMOS transistor PM delivers the output of the control circuit 160 into the gate of the first NMOS transistor N1.

Referring to FIG. 2, operations of the ESD protection circuit 100 when ESD occurs are as follows. The ESD detection circuit 140 detects an ESD current in the operating voltage VDD line, and causes the sensing node SN1 to have a logic HIGH voltage level. The control circuit 160 reverses an output of the sensing node SN1, outputs a logic LOW, and delivers the outputted logic LOW into the gate of the first NMOS transistor N1. Accordingly, a channel of the first NMOS transistor N1 is cut off. Therefore, the ESD current flowing in the operating voltage VDD line is not delivered into the first NMOS transistor N1, and the ESD current flowing in the operating voltage VDD line is discharged in the ground voltage VSS line through the ESD detection circuit 140. At this point, any voltage can be applied to the gate of the second NMOS transistor N2.

Referring to FIG. 2, when ESD does not occur, the ESD protection circuit 100 operates are as follows. The ESD detection circuit 140 causes the sensing node SN1 to have a logic LOW voltage level. The control circuit 160 reverses an output of the sensing node SN1, outputs a logic HIGH voltage level, and then delivers the logic HIGH voltage level into a gate of the first NMOS transistor N1. Accordingly, a channel of the first NMOS transistor N1 is opened. When the semiconductor device is in an output state, a logic HIGH voltage level is inputted into the gate of the second NMOS transistor N1, thereby enhancing the reliability of the gate oxide layer.

FIG. 4 is a circuit diagram of a semiconductor device having an ESD protection circuit according to further embodiments of the present invention. Referring to FIG. 4, the ESD protection circuit 100A includes a protection circuit 120A, an ESD detection circuit 140A, a control circuit 160A, and an internal circuit 200. The control circuit 160A includes a latch circuit 162 and a switch circuit 164.

The protection circuit 120A includes a PMOS transistor P, NMOS transistors N1 and N2, and a resistor R4. A source of the PMOS transistor P1 is connected to an operating voltage VDD line, its drain is connected to an input/output pad IO, and its gate is connected to its substrate. A drain of the first NMOS transistor N1 is connected to the input/output pad IO. A drain of the second NMOS transistor N2 is connected to a source of the first NMOS transistor N1, and its source is connected to the ground voltage VSS line. The resistor R4 is connected between the operating voltage VDD line and the gate of the first NMOS transistor N1.

The protection circuit 120A directs the ESD current of the input/output pad IO into the operating voltage VDD line through the PMOS transistor P, and into the ground voltage VSS line through the NMOS transistors N1 and N2 connected in a stacked configuration. The resistor R4 reduces the potential for an oxide layer to be damaged by an overvoltage due to an ESD current in the gate of the first NMOS transistor N1.

The ESD detection circuit 140A includes a capacitor C2 and a resistor R2. The capacitor C2 is connected between the operating voltage VDD line and the sensing node SN2. The capacitor C2 detects the ESD current flowing in the operating voltage VDD line when ESD occurs in the input/output pad IO.

When the ESD occurs in the input/output pad IO, a path where the ESD current flowing in the operating voltage VDD line flows is as follows. An electric potential of the input/output pad IO is increased by the ESD current. When the electric potential of the increased input/output pad IO exceeds a breakdown voltage of the PMOS transistor P, the ESD current flows into the operating voltage VDD line through the PMOS transistor P. The ESD current flowing into the operating voltage VDD line is charged into the capacitor C2, thereby increasing the voltage of the sensing node SN2.

The latch circuit 162 includes two inverters interlocked with one another. The latch circuit 162 reverses and latches an output of the ESD detection circuit 140, and then delivers the latched output into the switch circuit 164.

The latch circuit 162 includes a first inverter and a second inverter.

The first inverter includes a PMOS transistor PM3 and an NMOS transistor NM3. A source of the PMOS transistor PM3 is connected to the operating voltage VDD line. A drain of the NMOS transistor NM3 is connected to a drain of the PMOS transistor PM3, its source is connected to the ground voltage VSS line, and its gate is connected to a gate of the PMOS transistor PM3.

The second inverter includes a PMOS transistor PM4 and an NMOS transistor NM4. A source of the PMOS transistor PM4 is connected to the operating voltage VDD line. A drain of the NMOS transistor NM4 is connected to a drain of the PMOS transistor PM4, its source is connected to the ground voltage VSS line, and its gate is connected to a gate of the PMOS transistor PM4.

The gate of the PMOS transistor PM5 is connected to the drain of the PMOS transistor PM4. The drain of the PMOS transistor PM3 is connected to the gate of the PMOS transistor PM4.

The gate of the PMOS transistor PM3 is connected to the sensing node SN2 and receives an output of the ESD detection circuit 140A. The drain of the PMOS transistor PMOS delivers the output of the latch circuit 162 into the switch circuit 164.

The switch circuit includes a PMOS transistor PM5 and a resistor R3. The switch circuit 164 simultaneously opens channels of the first NMOS transistor N1 and the second NMOS transistor N2 in response to the output of the latch circuit 162 when ESD occurs.

A source of the PMOS transistor PM5 is connected to the operating voltage VDD line, its gate is connected to the output of the latch circuit 162, i.e., the drain of the PMOS transistor PM3. The resistor R3 is connected between the drain of the PMOS transistor PM5 and the ground voltage VSS line. The source of the PMOS transistor PM5 is connected to the gate of the first NMOS transistor N1. Additionally, the drain of the PMOS transistor PM5 is connected to the gate of the second NMOS transistor N2.

Referring to FIG. 4, when ESD occurs, operations of the ESD protection circuit are as follows. The ESD detection circuit 140A detects the ESD current flowing in the operating voltage VDD line and stores the ESD current in the capacitor C2. At this point, the voltage at the sensing node SN2 is a logic HIGH voltage level. The latch circuit 162 reverses the output of the sensing node SN2 and outputs a logic LOW voltage level. The latch circuit 162 outputs the logic LOW and then delivers the logic LOW into the switch circuit 164. The switch circuit 164 receives the logic LOW through the gate of the PMOS transistor PM5. Accordingly, the PMOS transistor PM5 is turned on, and the drain and the source of the PMOS transistor PM5 are raised to a logic HIGH voltage level. Consequently, the switch circuit 164 simultaneously opens channels of the first and second NMOS transistors N1 and N2.

Referring to FIG. 4, when ESD occurs, the ESD protection circuit 100A maintains the gates of the first NMOS transistor N1 and the second NMOS transistor N2 in a channel-on state. Consequently, the ESD protection circuit 120 may discourage the ESD current flowing in the operating voltage VDD line from being instantly concentrated on the gate of the first NMOS transistor N1. Accordingly, the ESD protection circuit 100A may reduce and/or prevent the protection circuit 120A from being damaged by the ESD current that flows in the operating voltage VDD line.

Referring to FIG. 4, when ESD does not occur, operations of the ESD protection circuit 100A are as follows. The detection circuit 140A generates a logic LOW voltage level at the sensing node SN2. The latch circuit 162 reverses an output of the sensing node SN2 and then outputs a logic HIGH. The latch circuit 162 outputs and delivers the logic HIGH into the switch circuit 164. The switch circuit 164 delivers the logic HIGH into the gate of the PMOS transistor PM5. Accordingly, the PMOS transistor PM5 is turned off.

At this point, the gate of the first NMOS transistor N1 is connected to the operating voltage VDD line. Accordingly, the first NMOS transistor N1 becomes always open. When the input/output pad IO of the semiconductor device is connected to an output buffer, the logic HIGH voltage level is applied to the gate of the second NMOS transistor N2 to enhance the reliability of an oxide layer in the MOS transistor.

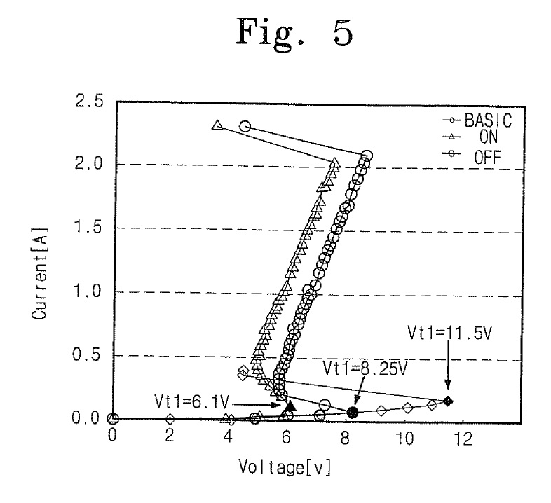

FIG. 5 is a view of current-voltage characteristics of semiconductor devices according to embodiments of the present invention. A first line Basic represents a current-voltage characteristic of a conventional ESD protection circuit. A second line OFF represents a current-voltage characteristic of the ESD protection circuit that cuts off channels of the stacked NMOS transistors N1 and N2. The second line OFF corresponds to embodiments of the semiconductor device having the ESD protection circuit 100 as shown in FIG. 2. A third line On represents a current-voltage characteristic of the ESD protection circuit that simultaneously opens channels of the stacked NMOS transistors N1 and N2. The third line On corresponds to embodiments of the semiconductor device having the ESD protection circuit 100A as illustrated in FIG. 4.

Referring to FIG. 5, Vt1 represents a first breakdown voltage of a transistor constituting the ESD protection circuit. The conventional ESD protection circuit has Vt1=11.5 V. On the other hand, the ESD protection circuit 100 according to the embodiments of FIG. 2 has Vt1=8.25 V and the ESD protection circuit 100A according to the embodiments of FIG. 4 has Vt1=6.1 V. Accordingly, a semiconductor device (ON or OFF) having an ESD protection circuit according to embodiments of the present invention may discharge ESD current more rapidly compared to a semiconductor device (BASIC) having a conventional ESD protection circuit. The semiconductor device ON having the ESD protection circuit 100A that simultaneously opens the channels of the stacked NMOS transistors may discharge the ESD current generated in the input/output pad IO more quickly compared to the semiconductor device OFF having the ESD protection circuit 100 that cuts off the channel of the stacked NMOS transistor.

As described above, a semiconductor device according to embodiments of the present invention includes an ESD detection circuit that detects an ESD current that flows in the operating voltage VDD line. The control circuit electrically grounds or cuts off the protection circuit in response to the detected ESD current, thereby reducing the possibility of damage to the ESD protection circuit, and/or discharging the ESD current more quickly.

In the drawings and specification, there have been disclosed typical embodiments of the invention and, although specific terms are employed, they are used in a generic and descriptive sense only and not for purposes of limitation, the scope of the invention being set forth in the following claims.

What is claimed is:

1. A semiconductor device comprising:
an input/output pad configured to receive a voltage higher than an operating voltage of the semiconductor device; and
an ESD (electro static discharge) protection circuit coupled to the input/output pad and configured to protect an internal circuit of the semiconductor device from an ESD current at the input/output pad,
wherein the ESD protection circuit comprises:
a protection circuit coupled to the input/output pad and configured to direct the ESD current into an operating voltage line and/or a ground voltage line;
an ESD detection circuit coupled to the operating voltage line and configured to detect the ESD current flowing in the operating voltage line and configured to generate an output signal in response to the ESD current flowing in the operating voltage line; and
a control circuit coupled to the ESD detection circuit and the protection circuit and configured to cause the protection circuit to be coupled to, or isolated from, the ground voltage line in response to the output signal from the ESD detection circuit.

2. The semiconductor device of claim 1, wherein the protection circuit comprises:
a PMOS transistor having a source connected to the operating voltage line, a drain connected to the input/output pad, and a date connected to a substrate;
a first NMOS transistor having a drain connected to the input/output pad; and
a second NMOS transistor having a drain connected to a source of the first NMOS transistor, and a source connected to the ground voltage line,
wherein the control circuit is configured to control a gate of the first NMOS transistor, and
the internal circuit is configured to control a gate of the second NMOS transistor.

3. The semiconductor device of claim 2, wherein the gate of the first NMOS transistor is connected to the operating voltage line when ESD does not occur.

4. The semiconductor device of claim 3, further comprising a resistor connected between the gate of the first NMOS transistor and the operating voltage line.

5. The semiconductor device of claim 3, wherein the control circuit is configured to cut off a channel of the first NMOS transistor in response to ESD.

6. The semiconductor device of claim 5 wherein the control circuit is configured to latch an output of the ESD detection circuit to cut off the channel of the first NMOS transistor.

7. The semiconductor device of claim 6, wherein the control circuit comprises:
a first inverter configured to receive and reverse an output of the ESD detection circuit, and configured to apply the reversed output to the gate of the first NMOS transistor; and
a second inverter configured to receive and reverse the output of the first inverter, and configured to apply the reversed output to the first inverter.

8. The semiconductor device of claim 7, wherein the first inverter comprises:
a first PMOS transistor having a source connected to the operating voltage line; and
a third NMOS transistor having a drain connected to a drain of the first PMOS transistor, a source connected to the ground voltage line, and a gate connected to a gate of the first PMOS transistor, and
the second inverter comprises:
a second PMOS transistor having a source connected to the operating voltage line; and
a fourth NMOS transistor having a drain connected to a drain of the second PMOS, a source connected to the ground voltage line, and a gate connected to a gate of the second PMOS transistor,
wherein the gate of the first PMOS transistor is connected to the drain of the second PMOS transistor and is configured to receive an output of the detection circuit, and wherein the drain of the first PMOS transistor is connected to the gate of the second PMOS transistor and is connected to the gate of the first NMOS transistor.

9. The semiconductor device of claim 8, wherein the ESD detection circuit comprises:
a capacitor connected to the operating voltage line and a sensing node; and
a resistor connected to the sensing node and the ground voltage line.

10. The semiconductor device of claim 1, wherein the protection circuit comprises:
a PMOS transistor having a source connected to the operating voltage line, a drain connected to the input/output pad, and a gate connected to a substrate;
a first NMOS transistor having a drain connected to the input/output pad; and
a second NMOS transistor having a drain connected to a source of the first NMOS transistor, and a source connected to the ground voltage line;
wherein the control circuit controls gates of the first NMOS transistor and the second NMOS transistor.

11. The semiconductor device of claim 10, wherein the gate of the first NMOS transistor is connected to the operating voltage line when ESD does not occur.

12. The semiconductor device of claim 11, further comprising a resistor between the gate of the first NMOS transistor and the operating voltage line.

13. The semiconductor device of claim 11, wherein the control circuit comprises:
a latch circuit configured to latch an output of the ESD detection circuit; and
a switch circuit configured to receive an output of the latch circuit and to open channels of the first and second NMOS transistors in response to the output of the latch circuit.

14. The semiconductor device of claim 13, wherein the ESD detection circuit comprises:
a capacitor connected to the operating voltage line and the sensing node; and
a resistor connected to the sensing node and the ground voltage line.

15. The semiconductor device of claim 14, wherein the latch circuit comprises:
a first inverter configured to reverse an output of the ESD detection circuit and to apply the reversed output to the switch circuit; and
a second inverter configured to reverse an output of the first inverter and to apply the reversed output to the first inverter.

16. The semiconductor device of claim 15, wherein the first inverter comprises:
a first PMOS transistor having a source connected to the operating voltage line; and
a third NMOS transistor having a drain connected to a drain of the first PMOS transistor, a source connected to the ground voltage line, and a Gate connected to a gate of the first PMOS transistor, and
wherein the second inverter comprises:
a second PMOS transistor having a source connected to the operating voltage line; and
a fourth NMOS transistor having a drain connected to a drain of the second PMOS, a source connected to the ground voltage line, and a gate connected to a gate of the second PMOS transistor;
wherein the gate of the first PMOS transistor is connected to the drain of the second PMOS transistor and is configured to receive an output of the detection circuit, and the drain of the first PMOS transistor is connected to the gate of the second PMOS transistor and connected to the gate of the first NMOS transistor.

17. The semiconductor device of claim 16, wherein the switching circuit comprises:
a third PMOS transistor having a source connected to the operating voltage line, and a gate configured to receive an output of the latch circuit; and
a resistor connected to a drain of the third PMOS transistor and the ground voltage line;
wherein the source of the third PMOS transistor is connected to the gate of the first NMOS transistor, and the drain of the third PMOS transistor is connected to the gate of the second NMOS transistor.

18. The semiconductor device of claim 1, wherein the input/output pad comprises a tolerant input/output pad.

19. A semiconductor device comprising
an input/output pad configured to receive a voltage higher than an operating voltage of the semiconductor device; and
an ESD (electro static discharge) protection circuit coupled to the input/output pad and configured to protect an internal circuit of the semiconductor device from ESD when ESD occurs at the input/output pad,
wherein the ESD protection circuit comprises;
a protection circuit coupled to the input/output pad and configured to direct ESD current into an operating voltage line and/or a ground voltage line;
an ESD detection circuit coupled to the operating voltage line and configured to detect the ESD current flowing in the operating voltage line and configured to generate an output signal in response to the ESD current flowing in the operating voltage line; and
a control circuit coupled to the ESD detection circuit and the protection circuit and configured to cause the protection circuit to be directly coupled to the around voltage line in response to the output signal from the ESD detection circuit.

20. A semiconductor device comprising:
an input/output pad configured to receive a voltage higher than an operating voltage of the semiconductor device; and
an ESD (electro static discharge) protection circuit coupled to the input/output pad and configured to protect an internal circuit of the semiconductor device from ESI) when ESD occurs at the input/output pad,
wherein the ESD protection circuit comprises:
a protection circuit coupled to the input/output pad and configured to direct ESD current into an operating voltage line and/or a ground voltage line;
an ESD detection circuit coupled to the operating voltage line and configured to detect the ESD current flowing in the operating voltage line and configured to generate an output signal in response to the ESD current flowing in the operating voltage line; and
a control circuit coupled to the ESD detection circuit and the protection circuit and configured to cause the protection circuit to be isolated from the ground voltage line in response to the output signal from the ESD detection circuit.
